(19) United States
(12) Patent Application Publication
(10) Pub. No.: US 2006/0014048 A1
(43) Pub. Date: Jan. 19, 2006

(54) Retardation plate

(75) Inventor: Damian Fiolka, Oberkochen (DE)

Correspondence Address: YOUNG & BASILE, P.C., 3001 WEST BIG BEAVER ROAD, SUITE 624, TROY, MI, 48084, US

(73) Assignee: Carl Zeiss SMT AG, Oberkochen (DE)

(21) Appl. No.: 11/182,599

(22) Filed: Jul. 15, 2005

Related U.S. Application Data
(63) Continuation of application No. PCT/EP03/01475, filed on Feb. 14, 2003.

(30) Foreign Application Priority Data
Jan. 16, 2003 (DE) 103 01 548.5

(51) Int. Cl. B32B 19/00

(52) U.S. Cl. 428/696; 428/702; 428/701

(57) ABSTRACT

A retardation plate comprises a birefringent crystal plate that has an entry face for incident light and an exit face for emerging light. The plate consists of an alkaline-earth metal fluoride and has an optical axis which is aligned along its <110> crystal axis or of a substantially equivalent principal crystal axis. A form-birefringent layer structure is applied to at least one of the faces of the crystal plate.

### CROSS-REFERENCE TO RELATED APPLICATIONS

This application is a continuation application of International Application PCT/EP2003/001475, with an international filing date of Feb. 14, 2003, which claims priority of German patent application DE 103 01 548, filed Jan. 16, 2003.

### BACKGROUND OF THE INVENTION

1. Field of the Invention

The present invention relates to a retardation plate with a birefringent crystal plate, which has an entry face and an exit face for incident and emerging light, respectively.

2. Description of Related Art

The term retardation plates, or phase plates, refers to optically birefringent plane-parallel plates, which generally consist of an optically uniaxial crystal. The surfaces of the retardation plate are parallel to the optic axis of the crystal, so that a normally incident wave is split into two waves oscillating mutually orthogonally with a phase difference dependent on the plate thickness. Behind the retardation plate, the light is combined to form a polarization state which depends on the plate thickness.

If, for example, this thickness is chosen so that the phase difference corresponds to one quarter of the wavelength of the incident light, then the retardation plate is referred to as a quarter-wave plate, which converts linearly polarized light into elliptically or circularly polarized light, and vice versa. If, however, the phase difference introduced between the polarization directions by the retardation plate is a half wavelength, then this is referred to as a half-wave plate, which, for example, can be used to invert the handedness of elliptically or circularly polarized light.

Retardation plates are used, for example, in catadioptric projection objectives of microlithographic projection illumination systems. Such systems are nowadays operated with such short-wave ultraviolet light that many birefringent crystalline materials are, owing to their excessive adsorption at these wavelengths, no longer viable as a material for retardation plates.

Magnesium fluoride is in principle suitable for this wavelength range, but it has such a high birefringence that very stringent requirements need to be placed on the manufacturing tolerances. Indeed, even very minor deviations from the intended thickness lead to a noticeable deviation from the desired phase difference between the orthogonal polarization directions. Owing to the high birefringence of magnesium fluoride, it is furthermore technologically difficult to produce zeroth-order retardation plates, in which the phase difference being introduced is exactly λ/4 and not, for instance, (n+¼)λ, with n=1, 2, . . . . Such zeroth-order retardation plates are in fact so thin that both their production and their handling in optical instruments entail significant problems. Zeroth-order retardation plates are generally preferred because their function depends less strongly on the angle at which the light strikes the retardation plate. This aspect is of particular importance in the aforementioned projection objectives, since these often have a numerical aperture of more than 0.3, so that large angles of incidence can occur.

### SUMMARY OF THE INVENTION

It is therefore an object of the invention to provide a retardation plate which is suitable for use in microlithographic projection illumination systems. In particular, the retardation plate is intended to have a high transparency in the ultraviolet spectral range, to be simple to produce and to handle, and furthermore to be usable even in wide-aperture optical systems.

This object is achieved by a retardation plate comprising a birefringent crystal plate that has an entry face for incident light and an exit face for emerging light, consists of an alkaline-earth metal fluoride and has an optical axis which is aligned at least approximately along its <110> crystal axis or of a substantially equivalent principal crystal axis. The plate further comprises a form-birefringent layer structure that is applied to at least one of the faces of the crystal plate.

The invention is based, on the one hand, on the fact that many alkaline-earth metal fluoride crystals, for example fluorite (CaF2) or barium fluoride crystals (BaF2), have an intrinsic birefringence for beam propagation along the direction of the <110> crystal axis. The birefringence for beam propagation along the other crystal axis directions, however, is small. Since these crystals have a high transparency in the ultraviolet wavelength range, they are suitable in particular for use in projection objectives of microlithographic projection illumination systems. Since the birefringence of these crystals is also comparatively small in the <110> direction, it is thereby possible to produce zeroth-order retardation plates which are not as thin as, for example, retardation plates made of magnesium fluoride. Less stringent requirements are therefore placed on the manufacturing tolerances relating to the plate thickness.

It has furthermore been found that, in form-birefringent layer structures such as those disclosed in U.S. Pat. No. 6,384,974 B1, for example, the angular dependency of the birefringent effect is different compared with <110> alkaline-earth fluoride crystals, and is in fact essentially reversed: although—as already mentioned above—the birefringence decreases with increasing angles of incidence in such crystals, the situation is precisely the opposite in the form-birefringent layer structure, that is to say the birefringence increases with increasing angle of incidence. In this way, the decreasing birefringence of the crystals at larger angles of incidence is compensated for at least partially by the birefringence of the layer structure, which then increases. With a suitable configuration of the layers, it is even possible to achieve a substantially angle-independent phase difference between orthogonally polarized components of the light.

Such a retardation plate is therefore also suitable for very wide-aperture objectives in projection illumination systems.

The form-birefringent layer structure may be configured as a periodic sequence of at least two layers with alternating refractive indices. The thicknesses of the layers must then be smaller than the wavelength for which the retardation plate is designed. The thicknesses of the layers are advantageously less than ⅕ or even 1/10 of this wavelength. In fact, the smaller the thicknesses of the layers are compared with the wavelength of the incident light, the more the layer structure acts as a homogeneous uniaxial birefringent medium for incident light. It is furthermore preferable for all the layers to have the same thickness.

### BRIEF DESCRIPTION OF THE DRAWINGS

Various features and advantages of the present invention may be more readily understood with reference to the following detailed description taken in conjunction with the accompanying drawings in which:

FIG. 1 represents a disc-shaped retardation plate in a section along its symmetry axis;

FIG. 2 shows a refractive index ellipsoid for a layer structure which is part of the retardation plate shown in FIG. 1.

### DESCRIPTION OF PREFERRED EMBODIMENTS

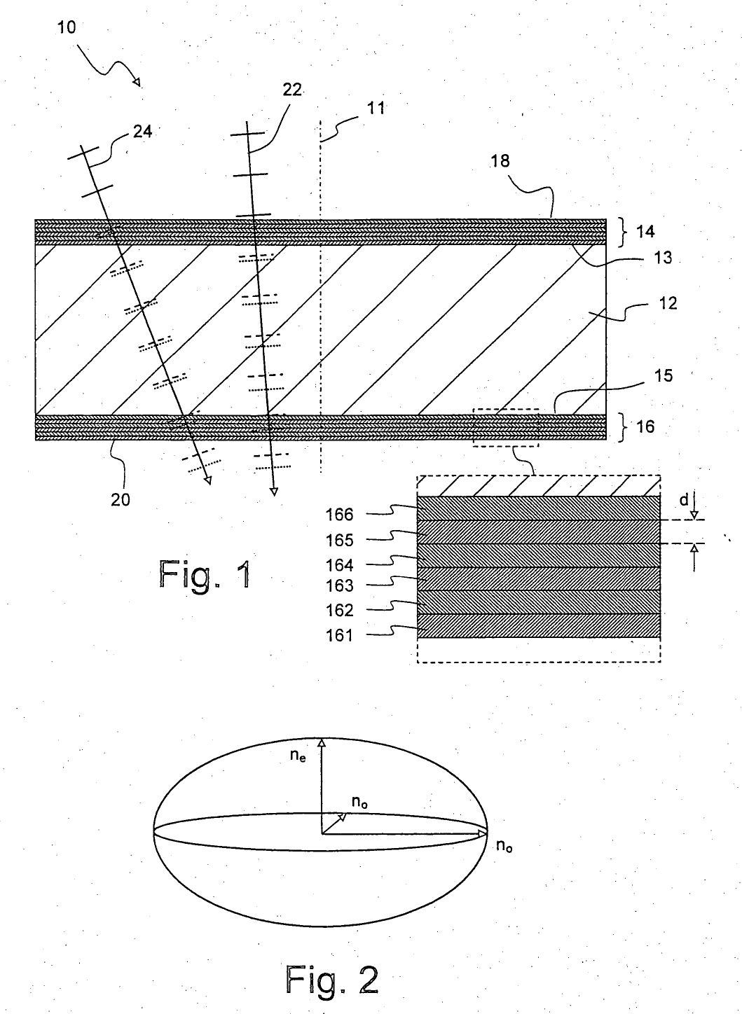

FIG. 1 shows a disc-shaped retardation plate, denoted in its entirety by 10, in a section along its symmetry axis. The retardation plate 10 has a fluorite crystal plate 12, whose optical axis indicated by 11 is aligned at least approximately in the direction of the <110> crystal axis.

An upper dielectric layer structure 14 and a lower dielectric layer structure 16 are applied to the upper and lower sides 13 and 15, respectively, of the fluorite crystal plate 12. As can be seen from the enlarged representation in FIG. 1, the lower layer structure 16 comprises a sequence of six dielectric layers 161, 162, . . . , 166 with an alternating refractive index. In the exemplary embodiment shown in the Figures, the layers 161, 163 and 165 have a first refractive index n1, whereas the layers 162, 164 and 166 have a second refractive index n2 which is different from the refractive index n1. All the layers 161, 162, . . . , 166 have the same thickness d, which, in the exemplary embodiment being represented, is 1/10 of the wavelength λ of the incident light. If the retardation plate 10 is designed, for example, for deep ultraviolet light having a wavelength λ=153 nm, then the thickness d is only about 15 nm. For the sake of clarity, the thickness of the individual layers 161, 162, . . . , 166 is consequently represented on a significantly exaggerated scale in FIG. 1.

The lower layer structure 16 is form-birefringent because of the alternating sequence of layers 161, 162, . . . , 166 with high and low refractive index. This means that the lower layer structure 16 has a differing refractive index, depending on the polarization direction of the light, for light incident obliquely to the layer planes. FIG. 2 shows a refractive-index ellipsoid for the lower layer structure 16. It is clear from this that light which is polarized parallel to the layer planes is exposed to the refractive index n0 for the ordinary beam, whereas light which is polarized perpendicularly to the layer planes is exposed to the refractive index ne for the extraordinary beam, with ne<n0.

The relationship between the refractive indices ne and n0, on the one hand, and the refractive indices n1 and n2 of the layers 161, 162, . . . , 166 as well as the layer thickness d, on the other hand, is described for example in the aforementioned U.S. Pat. No. 6,384,974.

Since light incident normally on the layer structure is always polarized parallel to the layer planes, the lower layer structure 16 is not birefringent for such a light beam. However, the larger the angle is between the layer planes and the light passing through, the stronger is the birefringent effect of the lower layer structure 16—at least for unpolarized or circularly polarized light.

The upper layer structure 14 is constructed precisely like the lower layer structure 16, so that the comments made above correspondingly apply here.

In FIG. 1, the birefringent effect of the upper and lower layer structures 14 and 16, as well as the fluorite crystal plate 12, is illustrated highly schematically for two linearly polarized light beams 22 and 24. The light beam 22 in this case strikes the entry face 18 of the retardation plate 10 in such a way that it passes normally through the upper layer structure 14. Owing to this normal transmission, as mentioned above, the light beam 22 is not exposed to any birefringence in the upper layer structure 14. As a consequence of this, splitting of the wavefronts does not take place there either. As soon as the wavefronts enter the fluorite crystal plate 12, however, the incident wave is split in the way typical of birefringence into an ordinary wave and an extraordinary wave, which are respectively illustrated in FIG. 1 as dashed and dotted wavefronts. This splitting of the wavefronts, and the concomitant increase in the phase difference, ends as soon as the wavefronts enter the lower layer structure 16, since the beam 22 is not exposed to any birefringence there. The emerging beam 22 has the desired phase difference of λ/4 or λ/2, corresponding to the thickness of the layer 12, between the two mutually orthogonally polarized components.

The second beam 24 is inclined relative to the first beam 22 in such a way that it strikes the entry face 18 of the retardation plate 10 at a large angle. For this angle of incidence, both the upper and lower layer structures 14 and 16 have a strongly birefringent effect, whereas the fluorite crystal plate 12 lying in-between is hardly at all birefringent for this angle of incidence. The splitting of the wavefronts introduced by the upper layer structure 14 is therefore substantially preserved during transmission through the fluorite crystal plate 12, until further splitting of the wavefronts takes place in the lower layer structure 16. As can be seen in FIG. 1, the layer structures 14 and 16 are configured in such a way that the overall splitting of the wavefronts, that is to say the phase difference introduced by the retardation plate 10 for the different polarization directions, corresponds approximately in the case of the beam 24 incident obliquely to the optical axis 11 to the phase difference which has been introduced by the retardation plate 10 for the beam 22 incident normally to the optical axis 11. In this way, the retardation plate 10 makes it possible to produce an approximately constant phase difference for light beams over a large range of angles of incidence.

What is claimed is:

1. A retardation plate, comprising:
a. a birefringent crystal plate that has an entry face for incident light and an exit face for emerging light,
consists of an alkaline-earth metal fluoride and has an optical axis which is aligned at least approximately along its <110> crystal axis or of a substantially equivalent principal crystal axis,
b. a form-birefringent layer structure that is applied to at least one of the faces of the crystal plate.

2. The retardation plate of claim 1, wherein the alkaline-earth metal fluoride is fluorite.

3. The retardation plate of claim 1, wherein the form-birefringent layer structure comprises a periodic sequence of at least two dielectric layers with alternating refractive indices.

4. The retardation plate of claim 3, wherein the thicknesses of the at least two layers are less than the wavelength for which the retardation plate is designed.

5. The retardation plate of claim 4, wherein the thicknesses of the at least two layers are less than ⅕ of the wavelength for which the retardation plate is designed.

6. The retardation plate of claim 5, wherein the thicknesses of the at least two layers are less than 1/10 of the wavelength for which the retardation plate is designed.

7. The retardation plate of claim 3, wherein the at least two layers have the same thickness.
